(19) United States
(12) Patent Application Publication
(10) Pub. No.: US 2016/0150916 A1
(43) Pub. Date: Jun. 2, 2016

(54) Cutting Board

(71) Applicants: Garry Colin McNally, Spearwood (AU); Edward Joseph Khoury, Bateman (AU)

(72) Inventors: Garry Colin McNally, Spearwood (AU); Edward Joseph Khoury, Bateman (AU)

(21) Appl. No.: 14/954,958

(22) Filed: Nov. 30, 2015

(30) Foreign Application Priority Data
Dec. 1, 2014 (AU) 2014904861

(51) Int. Cl. A47J 47/00

(52) U.S. Cl. CPC A47J 47/005

(57) ABSTRACT

A cutting board (10) comprising a planar member (12) having a surface on which items of food may be prepared. First and second recesses (22, 23) are provided in first and second side edges (14, 15) of the planar member (12) adjacent a first end (16) and first and second indents (26, 27) are provided in the first end (16) of the planar member (12) adjacent the recesses (22, 23). The first and second recesses (22, 23) and first and second indents (26, 27) define first and second projections (24, 25) located adjacent the intersection of the first and second side edges (14, 15) and the first end (16). First and second slots (28, 29) are provided in the first and second projections (24, 25) such that a bag (18) having first and second handles (20, 21) may be engaged with the cutting board (10) by wrapping the handles (20, 21) around the first and second projections (24, 25) respectively and engaging the first and second handles (20, 21) in the respective first and second slots (28, 29).

### FIELD OF THE INVENTION

The present invention relates to a board.

### BACKGROUND TO THE INVENTION

When using a cutting board to chop vegetables or other food items, it is common for portions of the food to be left over that require disposal. Generally, the cutting board is simply carried to a bin and the remaining food portions scraped off the cutting board into the bin.

The present invention relates to a cutting board having a particular configuration provided such that a bag having handles may be secured to the cutting board in a position for portions of food on the cutting board to be conveniently moved into the bag. The cutting board may be used, for example, with standard disposable shopping bags, to allow such bags to be re-used for disposal of food waste. The cutting board aims to provide easy and secure attachment of the bag to the cutting board.

### SUMMARY OF THE INVENTION

According to one aspect of the present invention there is provided a cutting board comprising:
a planar member having a surface on which items of food may be prepared;
a first recess in a first side edge of the planar member adjacent a first end thereof and a second recess in a second opposite side edge of the planar member adjacent the first end;
a first indent in the first end of the planar member adjacent the first recess and a second indent in the first end of the planar member adjacent the second recess, such that the first recess and the first indent define a first projection located adjacent the intersection of the first side edge and the first end the second recess and the second indent define a second projection located adjacent the intersection of the second side edge and the first end; and
first and second slots provided in the first and second projections;
wherein a bag having first and second handles may be engaged with the cutting board by wrapping the handles around the first and second projections respectively and engaging the first and second handles in the respective first and second slots.

Preferably the first slot is provided adjacent the first indent in the first end and the second slot is provided adjacent the second indent in the first end.

Preferably each of the first and second slots extend into the edge of the cutting board in a direction generally away from the first end towards the second end.

In a preferred embodiment, the first and second slots each include a narrowed outer portion adjacent the edge of the cutting board and a widened inner portion such that the narrowed outer portions of the slots are provided to restrict the handles of the bag from moving out of the slot once engaged.

In a preferred embodiment, the first and second recesses extend inwardly into the side edges such that that inner ends thereof lie generally on a line parallel to the side edges through the centre of the adjacent indent.

Preferably the first and second recesses each include a generally curved inner edge.

Preferably the first and second recesses extend into the first and second side edges of the planar member such that the recesses extend in a direction generally towards the first end of the planar member.

Preferably the first and second projections each comprise a relatively narrow neck portion and a relatively wide end portion.

In one embodiment, the planar member is rectangular.

### BRIEF DESCRIPTION OF THE DRAWINGS

The invention will now be described, by way of example, with reference to the following drawings in which:

FIG. 1 is an upper perspective view of a cutting board in accordance with the present invention;

FIG. 2 is a top view of the cutting board of FIG. 1;

FIG. 3a is a top view of the cutting board of FIG. 1;

FIG. 3b is a close up view of Detail A of FIG. 2a;

FIG. 4a is an upper perspective view of the cutting board of FIG. 1 shown engaged with a bag;

FIG. 4b is a close up view of a first handle of the bag shown in a first step of engagement with the cutting board;

FIG. 4c is a close up view of the first handle of the bag shown in a second step of engagement with the cutting board;

FIG. 4d is a close up view of the first handle of the bag shown engaged with the cutting board;

FIG. 5a is a top view of a second embodiment of a cutting board in accordance with the present invention;

FIG. 5b is an upper perspective view of the cutting board of FIG. 5a;

FIG. 6a is a top view of a third embodiment of a cutting board in accordance with the present invention; and

FIG. 6b is an upper perspective view of the cutting board of FIG. 6a.

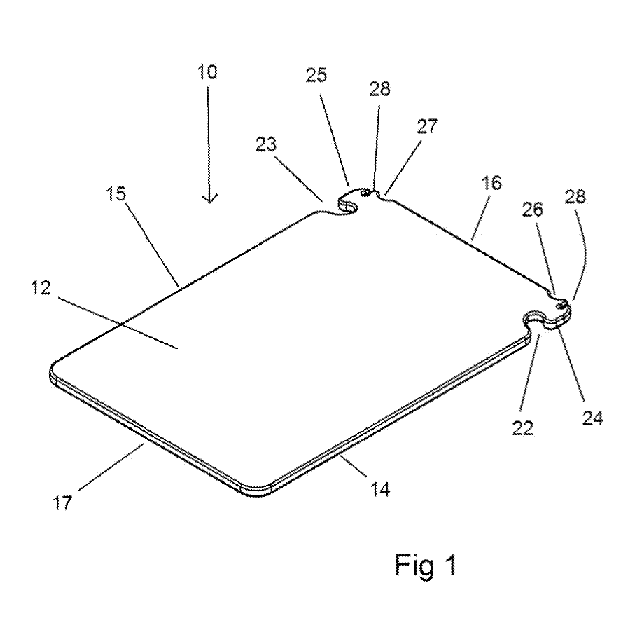

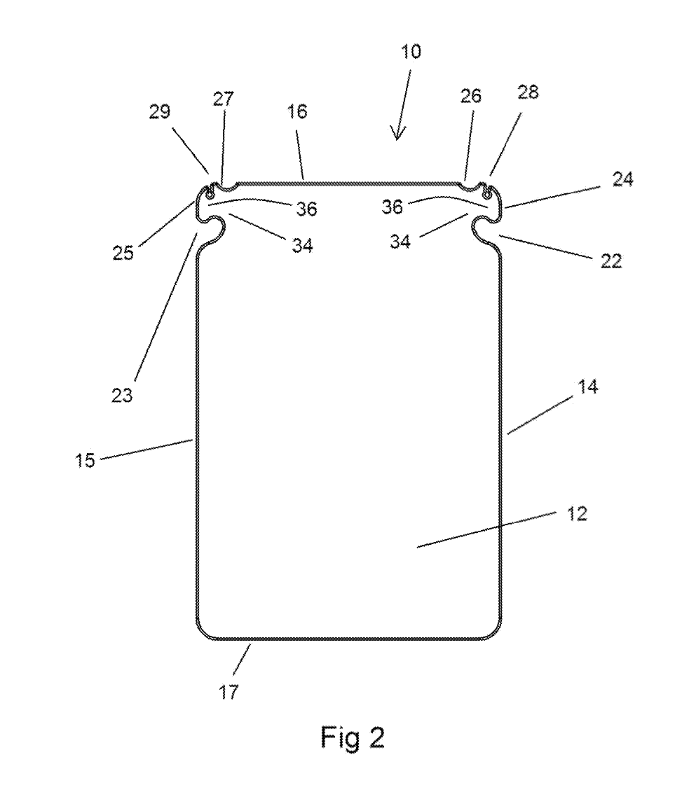

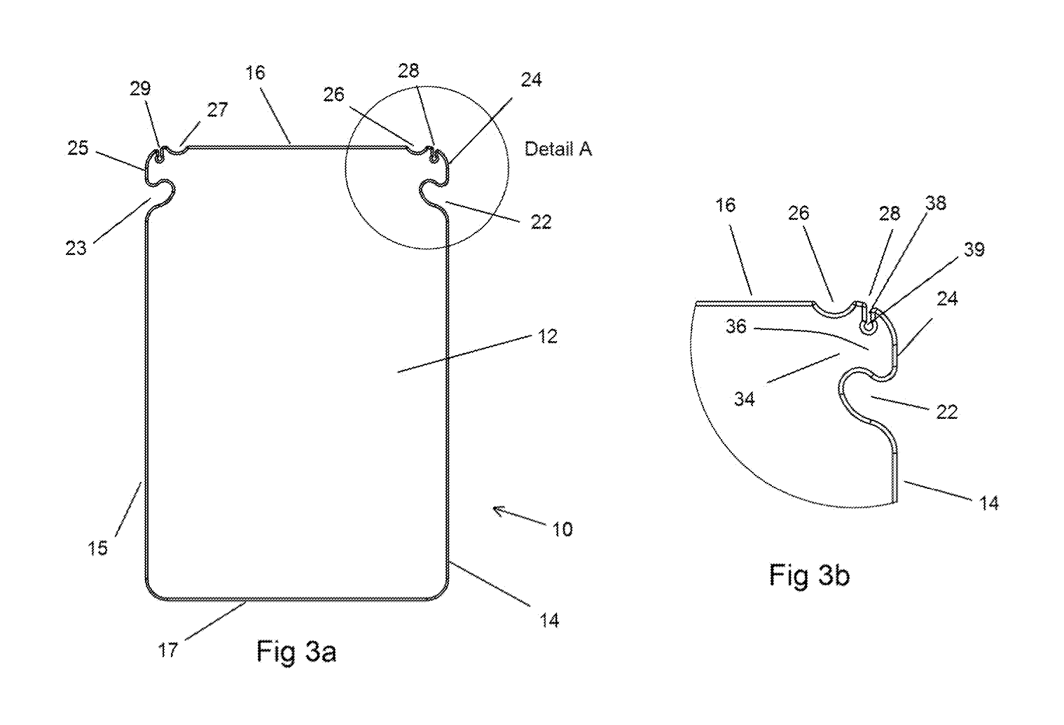

### DETAILED DESCRIPTION OF PREFERRED EMBODIMENTS

Referring to the Figures, there is shown a cutting board 10 comprising generally a planar member 12 of a suitable material. The planar member 12 in the embodiment shown is generally rectangular such that the planar member 12 includes linear first and second side edges 14 and 15 and linear first and second ends 16 and 17 being perpendicular to the first and second side edges 14 and 15.

The cutting board 10 is provided to support a bag 18, such as a standard disposable plastic shopping bag. The bag 18 includes a first handle 20 and a second handle 21 of a standard construction.

The cutting board 10 includes a first recess 22 provided in the first side edge 14 and a second recess 23 provided in the opposite second side edge 15. The first recess 22 includes a generally curved inner edge and is located adjacent the first end 16 of the planar member 12. The second recess 23 includes also a generally curved inner edge and is located adjacent the first end 16 of the planar member 12.

The first end 16 of the planar member 12 includes a first indent 26 located adjacent the first side edge 14. The first end 16 also includes a second indent 27 located adjacent the second side edge 15. The first and second indents 26 and 27 are generally arcuate in shape.

The first recess 22 and the first indent 26 thereby define a first projection 24 located adjacent the intersection of the first side edge 14 and the first end 16. The second recess 23 and the second indent 27 define a second projection 25 located adjacent the intersection of the second side edge 15 and the first end 16. Each of the first and second projections 24 and 25 comprises a relatively narrow neck portion 34 and a relatively wide end portion 36.

The first and second recesses 22 and 23 extend into the first and second side edges 14 and 15 of the planar member 12 such that the recesses 22 and 23 extend in a direction generally towards the first end 16 of the planar member 12. The recesses 22 and 23 extend inwardly into the side edges 14 and 15 such that that inner ends thereof lie generally on a line parallel to the side edges 14 and 15 through the centre of the adjacent indent 26 or 27.

The cutting board 10 is provided also with first and second slots 28 and 29. The first slot 28 is provided in the edge of the cutting board 10 between the first recess 24 and the first indent 26. That is, the first slot 18 is provided in the edge of the wide end portion 36 of the first projection 24. The second slot 29 is provided in the edge of the cutting board 10 between the second recess 25 and the second indent 27. That is, the second slot 29 is provided in the edge of the wide end portion 36 of the second projection 25.

Each of the first and second slots 28 and 29 extend into the edge of the cutting board 10 in a direction generally away from the first end 16 towards the second end 17. That is, the slots 28 and 29 lie on an axis parallel to the side edges 14 and 15. The first and second slots 28 and 29 include a narrowed outer portion 38 adjacent the edge of the cutting board 10 and a widened inner portion 39. The narrowed outer portions 38 of the slots 28 and 29 are provided such that a portion of the handle 20 or 21 of the bag 18 will be restricted from moving out of the slot 28 or 29 once engaged.

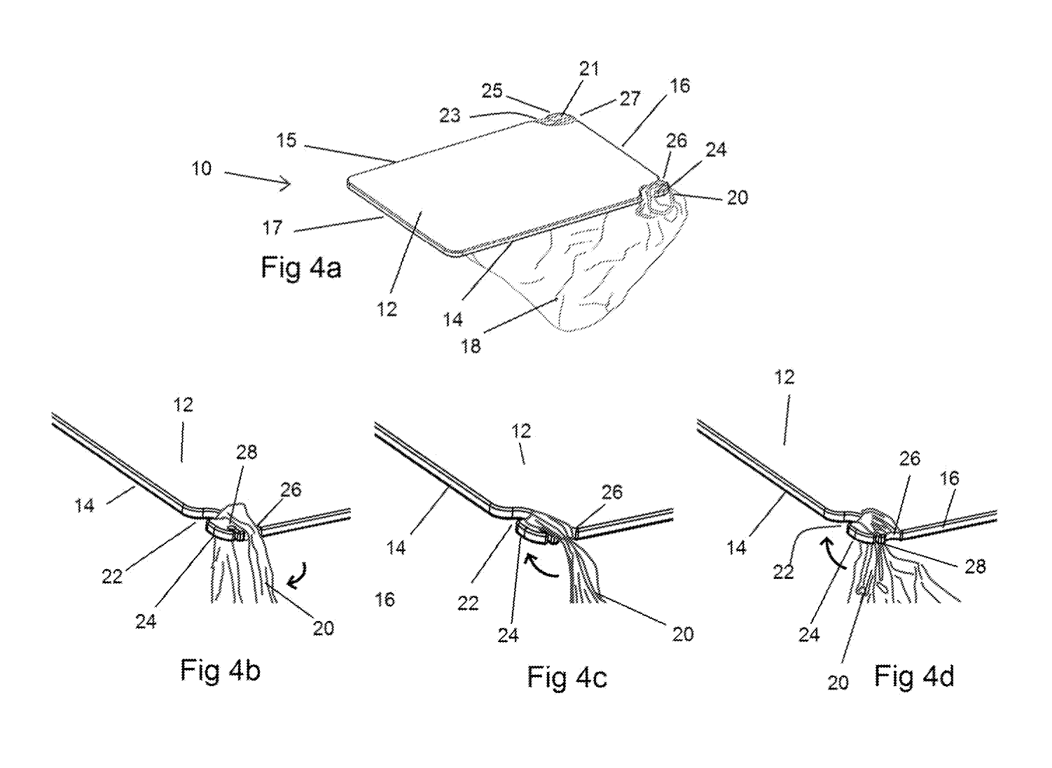

The cutting board 10 is provided to secure the bag 18 such that the bag 18 is supported adjacent and underneath the first end 16 thereof. The process of connecting the bag 18 to the cutting board 10 is as shown in FIG. 4. The first handle 20 is extended alongside the first side edge 14 and engaged into the first recess 22. The second handle 21 is extended alongside the second side edge 15 and engaged into the second recess 23. The first and second handles 20 and 21 are therefore looped over the first and second projections 24 and 25 respectively and the bag 18 hangs below the first end 16 (as can be seen in FIGS. 4a and 4b) with portions of the first and second handles 20 and 21 located in the first and second indents 26 and 27 respectively.

The first handle 20 is then gripped together adjacent first projection 24 and moved in a direction to wrap the first handle 20 around the first projection 24, as shown in FIG. 4c. The first handle 20 is then received into the first slot 28 to grip the first handle 20 tightly and retain the first handle 20 in place. The second handle 21 is then secured in the same manner by wrapping around the second projection 25 and engaging it into the second slot 29. Once secured to the cutting board 10, the bag 18 will be located below the cutting board 10 and can be left hanging over the edge of a bench top or other surface on which the cutting board 10 is to be used. Any food items to be thrown away can simply be wiped off the first end 16 of the cutting board 10 and into the bag 18 while the top of the bag 18 is held open. The bag 18 can then be detached from the cutting board 10 and thrown into the bin.

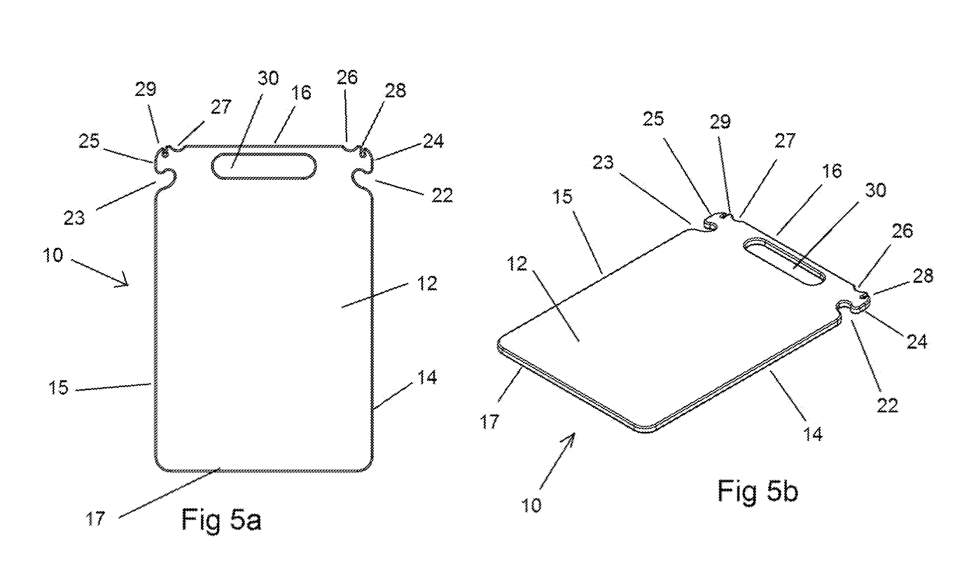

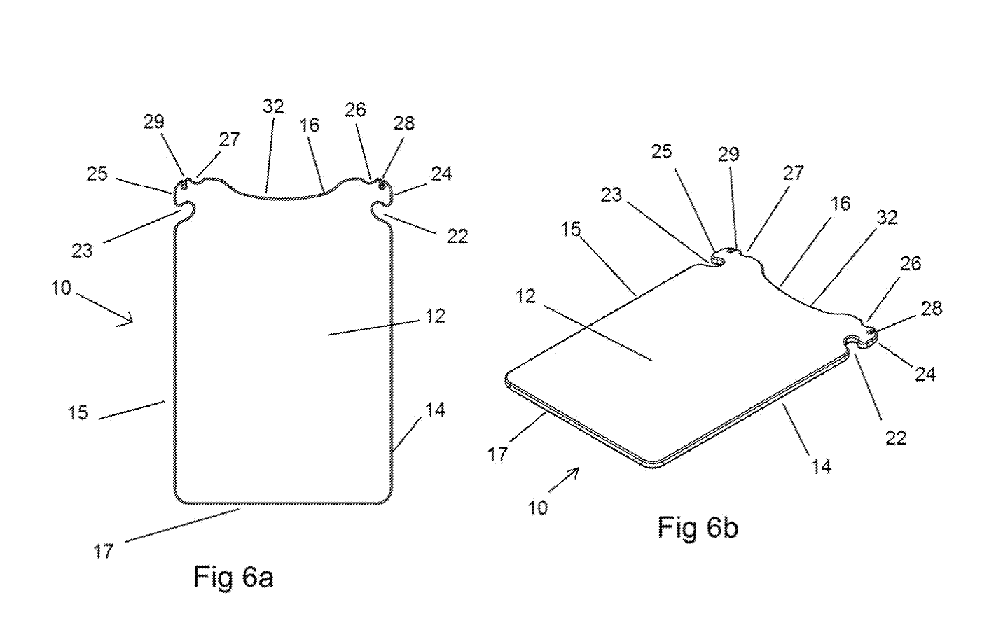

FIGS. 5 and 6 show alternative embodiments of cutting boards 10 in accordance with the present invention, where like reference numerals are used to denote Ike parts. The cutting board 10 of FIG. 5 includes an opening 30 adjacent the first end 16 to be used as a handle. The cutting board 10 of FIG. 6 includes a recessed portion 32 located centrally on the first end 16 to provide additional space for food to fall into the bag 18.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. A cutting board comprising:
a planar member having a surface on which items of food may prepared;
a first recess in a first side edge of the planar member adjacent a first end thereof and a second recess in a second opposite side edge of the planar member adjacent the first end;
a first indent in the first end of the planar member adjacent the first recess and a second indent in the first end of the planar member adjacent the second recess, such that the first recess and the first indent define a first projection located adjacent the intersection of the first side edge and the first end the second recess and the second indent define as second projection located adjacent the intersection of the second side edge and the first end; and
first and second slots provided in the first and second projections;
wherein a bag having first and second handles may be engaged with the cutting board by wrapping the handles around the first and second projections respectively and engaging the first and second handles in the respective first and second slots.

11. A cutting board in accordance with claim 10, wherein the first slot is provided adjacent the first indent in the first end and the second slot is provided adjacent the second indent in the first end.

12. A cutting board in accordance with claim 11, wherein each of the first and second slots extend into the edge of the cutting board in a direction generally away from the first end towards the second end.

13. A cutting board in accordance with claim 12, wherein the first and second slots each include a narrowed outer portion adjacent the edge of the cutting board and a widened inner portion such that the narrowed outer portions of the slots are provided to restrict the handles of the bag from moving out of the slot once engaged.

14. A cutting board in accordance with claim 10, wherein the first and second recesses extend inwardly into the side edges such that that inner ends thereof lie generally on a line parallel to the side edges through the center of the adjacent indent.

15. A cutting board in accordance with claim 10, wherein the first and second recesses each include a generally curved inner edge.

16. A cutting board in accordance with claim 15, wherein the first and second recesses extend into the first and second side edges of the planar member such that the recesses extend in a direction generally towards the first end of the planar member.

17. A cutting board in accordance with claim 16, wherein the first and second projections each comprise a relatively narrow neck portion and a relatively wide end portion.

18. A cutting board in accordance with claim 17, wherein the planar member is rectangular.
